(19) United States
(12) Patent Application Publication
(10) Pub. No.: US 2017/0322366 A1
(43) Pub. Date: Nov. 9, 2017

(54) OPTICAL MEMBER AND DISPLAY DEVICE HAVING THE SAME

(71) Applicant: Samsung Display Co., Ltd., Yongin-Si (KR)

(72) Inventors: Young-Min PARK, Hwaseong-si (KR); Yongkyu KANG, Hwaseong-si (KR); Eunju NAM, Seoul (KR); Min-Young SONG, Asan-si (KR)

(21) Appl. No.: 15/367,794

(22) Filed: Dec. 2, 2016

(30) Foreign Application Priority Data
May 9, 2016 (KR) 10-2016-0056641

(51) Int. Cl. F21V 8/00

(52) U.S. Cl. CPC G02B 6/0088; G02B 6/0085; G02B 6/0083; G02B 6/0073; G02B 6/0045; G02B 6/0058; G02B 6/0051; G02B 6/0068

(57) ABSTRACT

An optical member includes: a light guide part having a first refractive index, where a first area and a second area are sequentially defined on an upper surface of the light guide part in a first direction from a side surface of the light guide part; and a first pattern part disposed on the upper surface of the light guide part, having a second refractive index smaller than a first refractive index of the light guide part, where the first pattern part reflects a portion of light incident from the light guide part. A first area ratio of an overlapping portion of the first pattern part with the first area to the first area is greater than a second area ratio of an overlapping portion of the first pattern part with the second area to the second area.

This application claims priority to Korean Patent Application No. 10-2016-0056641, filed on May 9, 2016, and all the benefits accruing therefrom under 35 U.S.C. §119, the content of which in its entirety is herein incorporated by reference.

### BACKGROUND

### 1. Field

The disclosure relates to an optical member and a display device including the optical member. More particularly, the disclosure relates to an optical member having different light emitting efficiencies depending on a position thereof, and a display device including the optical member.

### 2. Description of the Related Art

Non-self emissive type display devices, such as a liquid crystal display, an electrophoretic display, an electrowetting display, etc., typically include a backlight unit for generating a light. The backlight unit may be classified into an edge-illumination type backlight unit and a direct-illumination type backlight unit according to a position of a light source with respect to a display surface on which an image is displayed. The edge-illumination type backlight unit may have a thickness smaller than that of the direct-illumination type backlight unit.

### SUMMARY

The disclosure is directed to an optical member having different light emitting efficiencies depending on a position thereof.

The disclosure is directed to a display device including the optical member.

According to an embodiment of the inventive concept, an optical member includes: a light guide part having a first refractive index, where a first area and a second area are sequentially defined on an upper surface of the light guide part in a first direction from a side surface of the light guiding part; and a first pattern part disposed on the upper surface of the light guide part and having a second refractive index smaller than the first refractive index. In such an embodiment, the first pattern part reflects a portion of a light incident from the light guide part, a first area ratio of an overlapping portion of the first pattern part with the first area to the first area is greater than a second area ratio of an overlapping portion of the first pattern part with the second area to the second area.

In an embodiment, the first pattern part may include a control pattern, the control pattern may extend in the first direction, and a width of the control pattern in a second direction crossing the first direction in the first area may be equal to or greater than a maximum width of the control pattern in the second direction in the second area.

In an embodiment, the first pattern part may include a plurality of control patterns, each of the plurality of control patterns may extend in a second direction crossing the first direction, the plurality of control patterns may be arranged in the first direction, a width of a control pattern in the first direction in the first area among the plurality of control patterns may be greater than a width of a control pattern in the first direction in the second area among the control patterns.

In an embodiment, the first pattern part may include a plurality of control patterns, each of the plurality of control patterns may extend in a second direction crossing the first direction, the plurality of control patterns may be arranged in the first direction, and a pitch between the control patterns disposed in the first area among the plurality of control patterns may be smaller than a minimum pitch between the control patterns disposed in the second area among the plurality of control patterns.

In an embodiment, the optical member may further include an adhesive part which covers the first pattern part, and a second pattern part attached to the adhesive part.

In an embodiment, the first pattern part may include a plurality of control patterns, the second pattern part may include a plurality of light condensing patterns, a density of the light condensing patterns in the first area may be the same as a density of the light condensing patterns in the second area, and the plurality of control patterns may overlap the plurality of light condensing patterns when viewed from a plan view in a thickness direction of the light guide part.

In an embodiment, an area of a control pattern disposed in the first area among the plurality of control patterns is greater than a maximum area of the control patterns disposed in the second area among the plurality of control patterns.

In an embodiment, a number of the control patterns disposed in the first area among the plurality of control patterns may be greater than a number of the control patterns disposed in the second area among the plurality of control patterns.

In an embodiment, a difference between the first refractive index and the second refractive index may be equal to or greater than about 0.05.

In an embodiment, a third area may be defined on the upper surface of the light guide part to face the first area such that the second area is disposed between the first area and the third area, and a third area ratio of an overlapping portion of the first pattern part with the third area to the third area may be greater than the second area ratio.

In an embodiment, the first pattern part may have a shape symmetrical with respect to an imaginary center line crossing a center of the second area in a second direction crossing the first direction.

In an embodiment, the first pattern part may make contact with the light guide part, and a portion of the light traveling to the first pattern part through the light guide part may be reflected by a boundary surface between the first pattern part and the light guide part.

According to another embodiment of the inventive concept, a display device includes: a display panel which displays an image; an optical member disposed under the display panel, where the optical member includes a light guide part having a first refractive index and including a first side surface, a second side surface opposite to the first side surface, and an upper surface connecting the first side surface and the second side surface, a first pattern part having a second refractive index smaller than the first refractive index and disposed on the upper surface of the light guide part, and a second pattern part disposed on the first pattern part; and a first light source unit disposed to face the first side surface and which provides a light to the first side surface. In such an embodiment, a first area and a second area are sequentially defined on the upper surface in a first direction from the first side surface to the second side surface, and a first area ratio of an overlapping portion of the first pattern part with the first area to the first area is greater than a second area ratio of an overlapping portion of the first pattern part with the second area to the second area.

In an embodiment, a difference between the first refractive index and the second refractive index may be equal to or greater than about 0.05.

In an embodiment, the first pattern part may include a control pattern, the control pattern may extend in the first direction, and a width of the control pattern in a second direction crossing the first direction may decrease as a distance from the second side surface decreases.

In an embodiment, the first pattern part may include a plurality of control patterns, the plurality of control patterns may be arranged in the first direction, and each of the plurality of control patterns may extend in a second direction crossing the first direction.

In an embodiment, the control patterns may have a same width in the first direction as each other, and a pitch between two control patterns adjacent to each other among the plurality of control patterns may increase as a distance from the second side surface decreases.

In an embodiment, the control patterns may have different widths in the first direction from each other, and a width in the first direction of the control patterns may decrease as a distance from the second side surface decreases.

In an embodiment, a pitch between two adjacent control patterns among the plurality of control patterns may be constant.

In an embodiment, the display device may further include an adhesive part covering the first pattern part, where the second pattern part may include a film and a plurality of light condensing patterns disposed between a first surface of the film and the adhesive part, and the plurality of light condensing patterns may be attached to the light guide part by the adhesive part.

In an embodiment, a density of the light condensing patterns in the first area may be the same as a density of the light condensing patterns in the second area.

In an embodiment, the first pattern part may include a plurality of control patterns, and the plurality of control patterns may overlap the plurality of light condensing patterns when viewed from a plan view in a thickness direction of the light guide part.

In an embodiment, an area of the control patterns may decrease as a distance from the second side surface decreases.

In an embodiment, the number of the control patterns disposed in the first area among the plurality of control patterns may be greater than the number of the control patterns disposed in the second area among the plurality of control patterns.

In an embodiment, the second pattern part may further include a plurality of diffusion patterns disposed on a second surface of the film facing the first surface.

In an embodiment, the display device may further include a second light source unit disposed to face the second side surface, where the second light source provides a light to the second side surface, a third area may be defined on the upper surface of the light guide part to face the first area such that the second area is disposed between the first area and the third area, and a third area ratio of an overlapping portion of the first pattern part with the third area to the third area is greater than the second area ratio.

In an embodiment, the first pattern part may have a shape symmetrical with respect to an imaginary center line crossing a center of the second area and extending in a second direction crossing the first direction.

In an embodiment, the first pattern part may make contact with the light guide part, and a portion of the light traveling to the first pattern part through the light guide part may be reflected at a boundary surface between the first pattern part and the light guide part.

According to another embodiment of the inventive concept, a display device includes: a display panel which displays an image; a backlight unit disposed under the display panel, wherein the backlight unit provides a light to the display panel, where the backlight unit includes an optical member disposed under the display panel, and a light source which generates the light and provides the light to the optical member. In such an embodiment, the optical member includes: a light guide part having a first refractive index, wherein a side surface of the light guide part faces the light source to receive the light; a first pattern part disposed on the upper surface of the light guide part and having a second refractive index smaller than the first refractive index, wherein the first pattern part reflects a portion of the light guided by the light guide part and incident thereto; and a second pattern part comprising a plurality of light condensing patterns. In such an embodiment, a first area and a second area are defined in an upper surface of the light guide part, a distance of the first area from the light source is less than a distance of the second area from the light source, and a first area ratio of an overlapping portion of the first pattern part with the first area to the first area is greater than a second area ratio of an overlapping portion of the first pattern part with the second area to the second area

In an embodiment, the optical member may further include: an adhesive part which covers the first pattern part, where the second pattern part may be attached to the adhesive part.

In an embodiment, the second light condensing patterns may be uniformly distributed on the upper surface of the light guide part when viewed from a plan view in a thickness direction of the light guide part.

In an embodiment, a difference between the first refractive index and the second refractive index may be equal to or greater than about 0.05.

In an embodiment, the first pattern part may be in direct contact with the light guide part, and a portion of the light traveling through the light guide part and incident to the first pattern part may be totally reflected at a boundary surface between the first pattern part and the light guide part.

According to embodiments, the light emitting efficiency becomes different depending on the position in the optical member, and thus the light having uniform brightness may be provided to the display panel.

### BRIEF DESCRIPTION OF THE DRAWINGS

The above and other features of the disclosure will become readily apparent by reference to the following detailed description when considered in conjunction with the accompanying drawings, in which:

FIG. 1 is an exploded perspective view showing a display device according to an exemplary embodiment of the disclosure;

FIG. 2A is a cross-sectional view showing a backlight unit according to an exemplary embodiment of the disclosure;

FIG. 2B is a cross-sectional view showing a backlight unit according to an alternative exemplary embodiment of the disclosure;

FIG. 3 is a plan view showing a backlight unit according to an exemplary embodiment of the disclosure;

FIG. 4 is a plan view showing a backlight unit according to an alternative exemplary embodiment of the disclosure;

FIG. 5 is a plan view showing a backlight unit according to another alternative exemplary embodiment of the disclosure;

FIG. 6A is a plan view showing a backlight unit according to another alternative exemplary embodiment of the disclosure;

FIG. 6B is an enlarged plan view of portions Aa, Ab and Ac shown in FIG. 6A;

FIG. 7 is a plan view showing a backlight unit according to another alternative exemplary embodiment of the disclosure;

FIG. 8 is a plan view showing a backlight unit according to another alternative exemplary embodiment of the disclosure;

FIG. 9 is a cross-sectional view showing the backlight unit shown in FIG. 8; and

FIGS. 10A to 10F are views showing a method of manufacturing an optical member according to an exemplary embodiment of the disclosure.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of the invention will be described in detail with reference to the accompanying drawings.

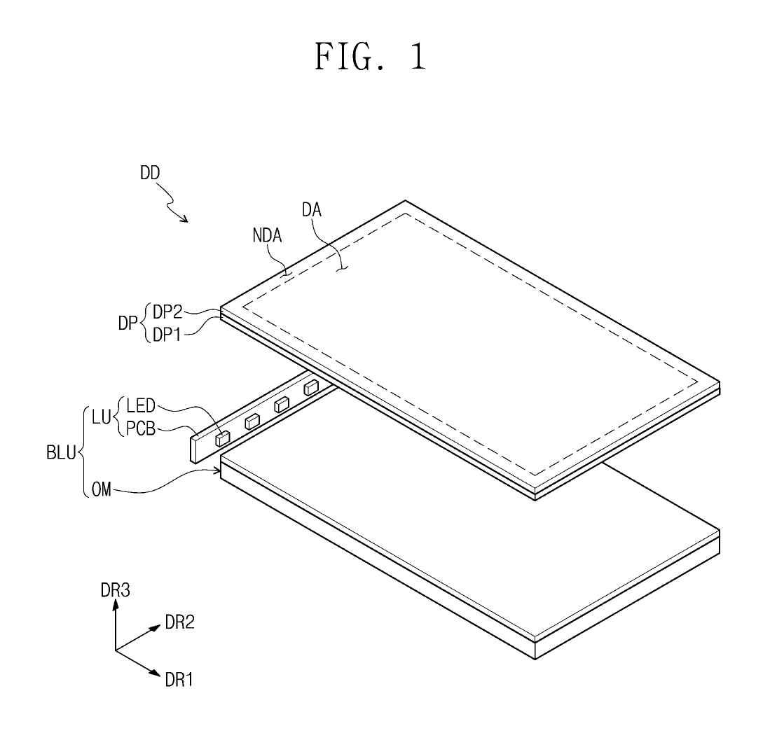

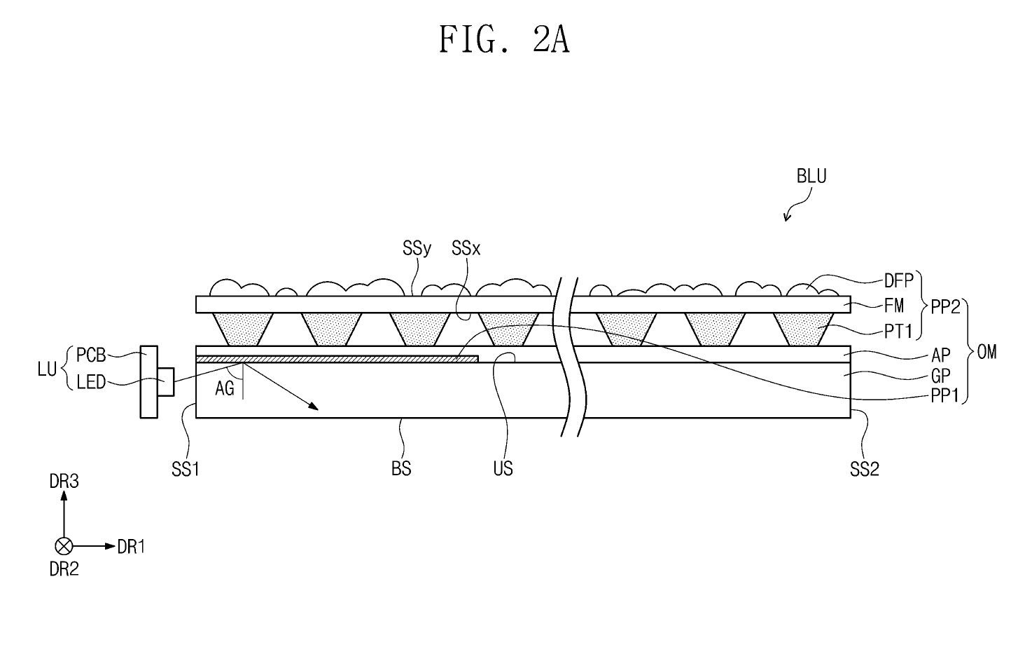

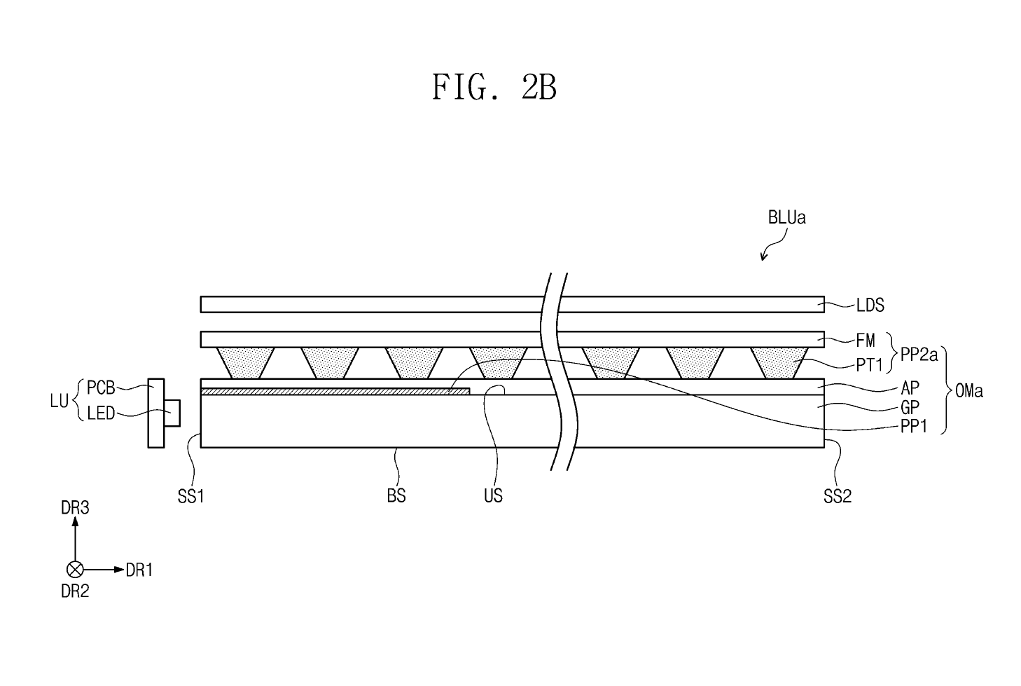

FIG. 1 is an exploded perspective view showing a display device DD according to an exemplary embodiment of the disclosure, and FIG. 2A is a cross-sectional view showing a backlight unit according to an exemplary embodiment of the disclosure.

Referring to FIGS. 1 and 2A, an exemplary embodiment of the display device DD may be included in or applied to a small and medium-sized electronic device, such as a tablet personal computer (“PC”), a smart phone, a car navigation unit, a camera, a central information display (“CID”) for a vehicle, a wrist-type electronic device, a personal digital assistant (“PDA”), a portable multimedia player (“PMP”) and a game unit, for example, or various electronic devices, such as a television set, an outdoor billboard, a monitor, a personal computer and a notebook computer, for example, but not being limited thereto or thereby.

In an exemplary embodiment, the display device DD includes a display panel DP and a backlight unit BLU.

The display panel DP displays an image corresponding to an image data input thereto. The display panel DP includes a display area DA and a non-display area NDA defined in a display surface thereof. The display area DA displays an image, the non-display area NDA surrounds the display area DA, and no image is displayed in the non-display area NDA.

In such an embodiment, the display panel DP may be a liquid crystal display panel, a plasma display panel, an electrophoretic display panel or an electrowetting display panel, but not being limited thereto or thereby. Hereinafter, for convenience of description, an exemplary embodiment where the display panel DP is the liquid crystal display panel will be described in detail.

In such an embodiment, the display panel DP includes a first substrate DP1, a second substrate DP2 facing the first substrate DP1, and a liquid crystal layer interposed between the first substrate DP1 and the second substrate DP2. The liquid crystal layer includes a plurality of liquid crystal molecules, and an alignment of the liquid crystal molecules is changed in accordance with an electric field generated between the first substrate DP1 and the second substrate DP2. Although not shown in figures, polarizing plates may be respectively disposed on an upper surface and a lower surface of the display panel DP.

The backlight unit BLU provides a light to the display panel DP. The backlight unit BLU may include a light source unit LU and an optical member OM.

The light source unit LU is disposed adjacent to a side of the optical member OM, which may include short sides and long sides. In an exemplary embodiment, as shown in FIG. 1, the optical member OM may include two long sides and two short sides, and the light source unit LU is disposed along or adjacent to one of the short side of the optical member OM.

The light source unit LU may include a light source LED and a printed circuit board PCB. The light source LED is disposed or mounted on the printed circuit board PCB, and receives a driving voltage through the printed circuit board PCB. The light source LED provides the light to the optical member OM in response to the driving voltage. Although not shown in figures, the light source unit LU may further include a heat discharge member having a bar-like shape (not shown) and attached to a rear surface of the printed circuit board PCB. The heat discharge member discharges a heat generated from the printed circuit board PCB and the light source LED to an outside of the printed circuit board PCB and the light source LED.

In an exemplary embodiment, as shown in FIG. 2A, the optical member OM may include a light guide part GP, a first pattern part PP1, an adhesive part AP and a second pattern part PP2.

The light guide part GP guides the light provided from the light source unit LU. The light guide part GP includes a first side surface SS1, a second side surface SS2, an upper surface US, and a lower surface BS.

The first side surface SS1 faces the light source unit LU and receives the light from the light source unit LU. The first side surface SS1 may be referred to as a light incident surface. The second side surface SS2 faces the first side surface SS1. The second side surface SS2 is spaced apart from the first side surface SS1 in a first direction DR1. The second side surface SS2 may be referred to as a light opposite surface.

The upper surface US connects the first side surface SS1 and the second side surface SS2. The upper surface US may be referred to as a light exit surface since the light guided by the light guide part GP exits through the upper surface US. The lower surface BS connects the first side surface SS1 and the second side surface SS2 and faces the upper surface US. In an exemplary embodiment, an additional optical pattern may be disposed on the lower surface BS to realize various optical functions, such as reflection, scattering or refraction, for example, but not being limited thereto or thereby.

In an exemplary embodiment, the light guide part GP has a quadrangular shape when viewed from a plan view. In such an embodiment, the light guide part GP may have the quadrangular shape when the display device DD is viewed from a top plan view in a thickness direction DR3 (hereinafter, referred to as a third direction), but not being limited thereto or thereby. In one alternative exemplary embodiment, for example, the light guide part GP may have a curved shape in a first direction DR1 or a second direction DR2. In another alternative exemplary embodiment, the light guide part GP may have a trapezoidal shape or a fan shape in which the second side surface SS2 is curved, when viewed in the plan view. The shape of the light guide part GP may be modified into various shapes.

The light guide part GP has a first refractive index. In one exemplary embodiment, for example, the first refractive index may be in a range from about 1.45 to about 1.6. The light guide part GP may include at least one of polyamide (“PA”), polymethyl methacrylate (“PMMA”), methylmethacrylate-styrene (“MS”), and polycarbonate (“PC”), but not being limited thereto or thereby.

The first pattern part PP1 is disposed on the upper surface US of the light guide part GP. The first pattern part PP1 may be in direct contact with the light guide part GP. The first pattern part PP1 has a second refractive index that is smaller than the first refractive index. A difference between the first refractive index and the second refractive index may be equal to or greater than about 0.05, but not being limited thereto or thereby. The material included in the first pattern part PP1 may not be limited to any specific material as long as the material has a refractive index smaller than the light guide part GP. In one exemplary embodiment, for example, where the light guide part GP includes PC having a refractive index of about 1.59, the first pattern part PP1 may include PMMA having a refractive index of about 1.49.

Among the light traveling to the first pattern part PP1 through the light guide part GP, a light having an incident angle AG greater than a critical angle may be totally reflected at a boundary surface between the light guide part GP and the first pattern part PP1. As an amount of the light totally reflected at the boundary surface between the light guide part GP and the first pattern part PP1 increases, a light emitting efficiency may decrease. In an exemplary embodiment, the light emitting efficiency may be controlled by adjusting a density of the first pattern part PP1 on the upper surface US or an area ratio of the first pattern part PP1 to the upper surface US.

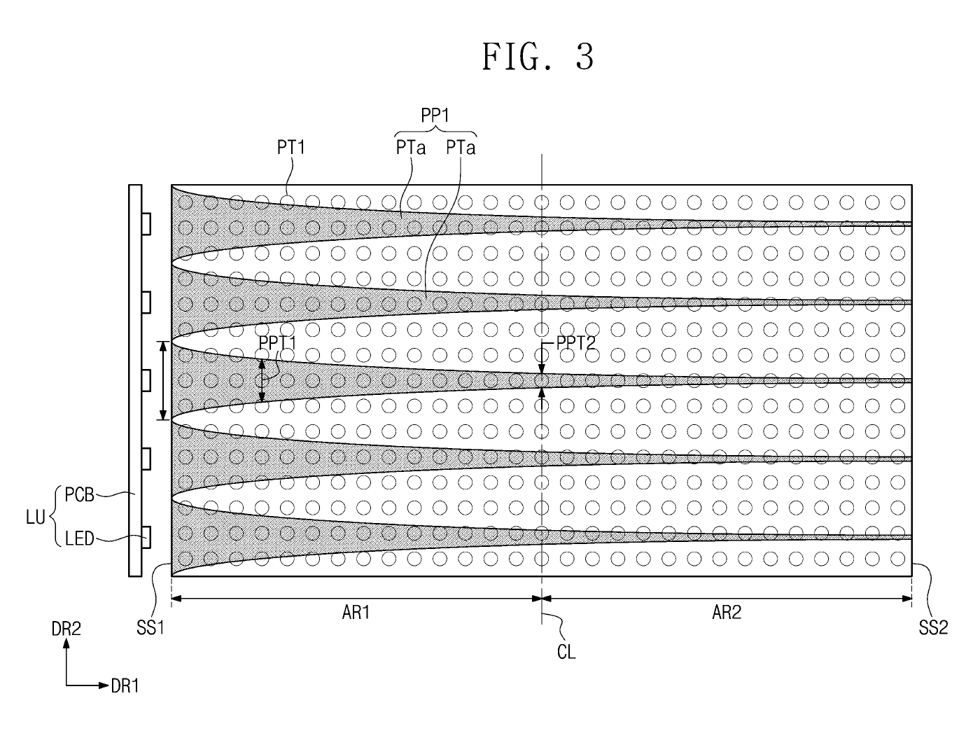

An amount of light incident to an area of the upper surface US adjacent to the first side surface SS1, to which the light is incident, is different from an amount of light incident to an area of the upper surface US relatively far from the first side surface SS1. Therefore, in a case that the light emitting efficiency is constant over an entire upper surface US, the light having a non-uniform brightness may be provided to the display panel DP. In an exemplary embodiment, the amount of the totally reflected light may be controlled by adjusting the area ratio of the first pattern part PP1, such that the backlight unit provides the light having uniform brightness to the display panel DP by setting or controlling the light emitting efficiency to be different depending on a position in the light guide part GP. Details thereof will be described later with reference to FIG. 3.

In an exemplary embodiment, as shown in FIG. 2A, the adhesive part AP covers the first pattern part PP1 and is disposed on the light guide part GP. The adhesive part AP may be an optical clear resin or a resin having high transmittance.

In such an embodiment, the second pattern part PP2 may be disposed on the adhesive part AP. The second pattern part PP2 may be attached to the light guide part GP by the adhesive part AP.

The second pattern part PP2 may include a film FM, light condensing patterns PT1, and diffusion patterns DFP. The light condensing patterns PT1 are disposed on a first surface SSx, e.g., a lower surface, of the film FM, and the diffusion patterns DFP are disposed on a second surface SSy, e.g., an upper surface, of the film FM. The diffusion patterns DFP may include diffusion beads to diffuse the light.

The light condensing patterns PT1 are attached to the adhesive part AP. Each of the light condensing patterns PT1 may have a trapezoidal cross-sectional shape with a plane defined by the first direction DR1 and the third direction DR3 substantially perpendicular to the upper surface US of the light guide part GP. However, the cross-sectional shape of the light condensing patterns PT1 may not be limited to the trapezoidal shape, and the cross-sectional shape of the light condensing patterns PT1 may be modified in various ways.

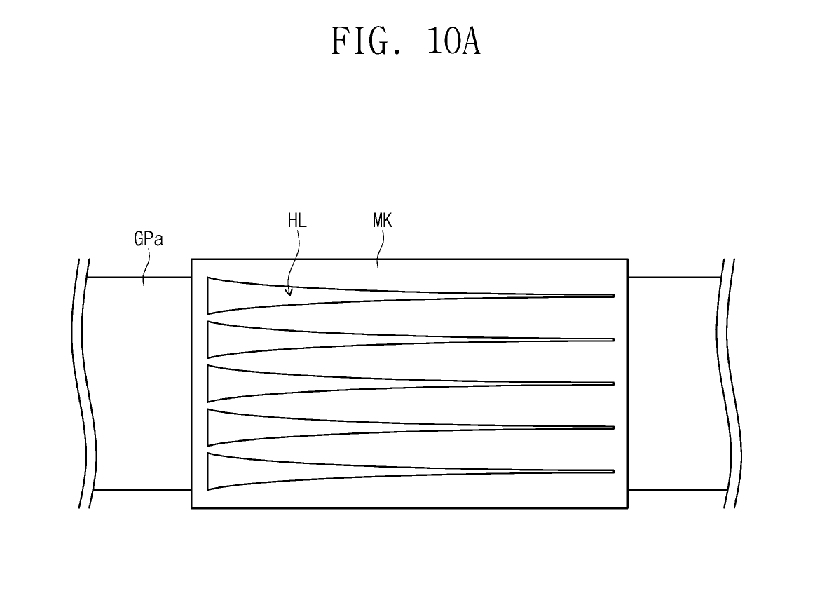

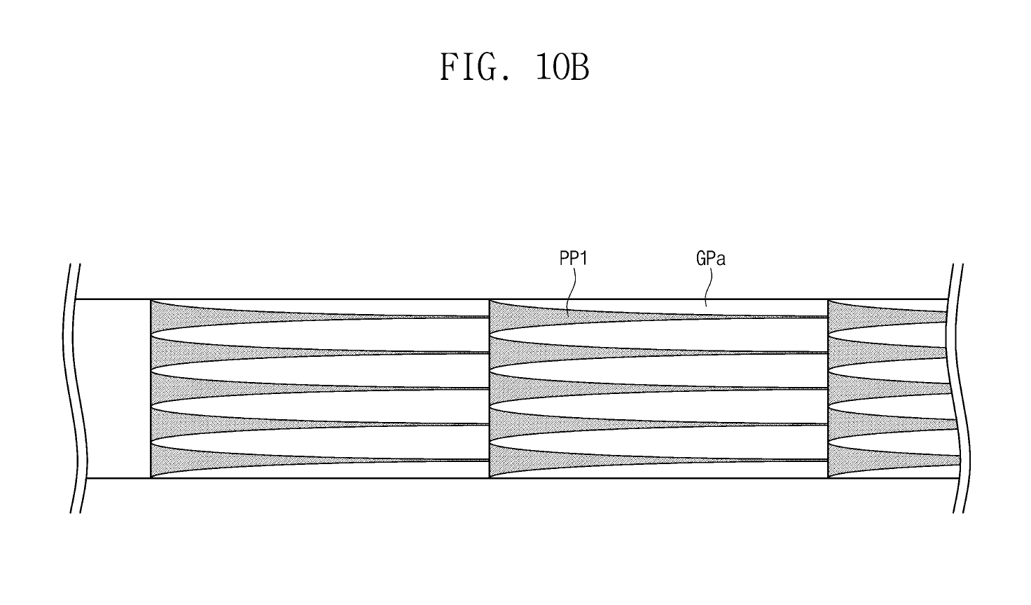

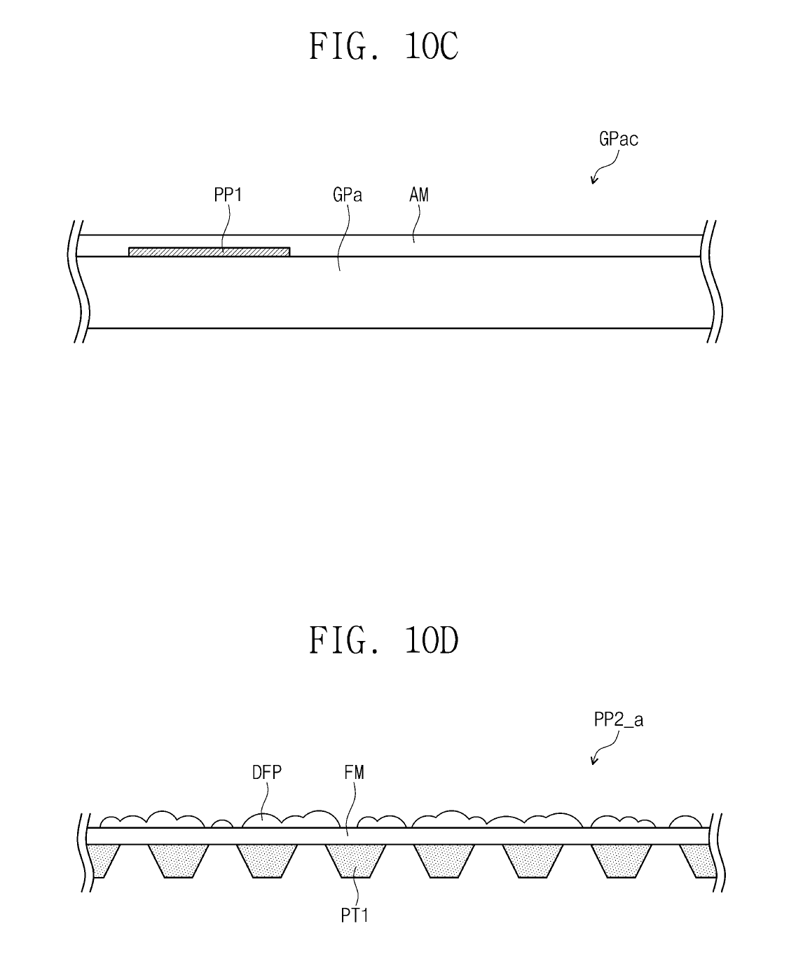

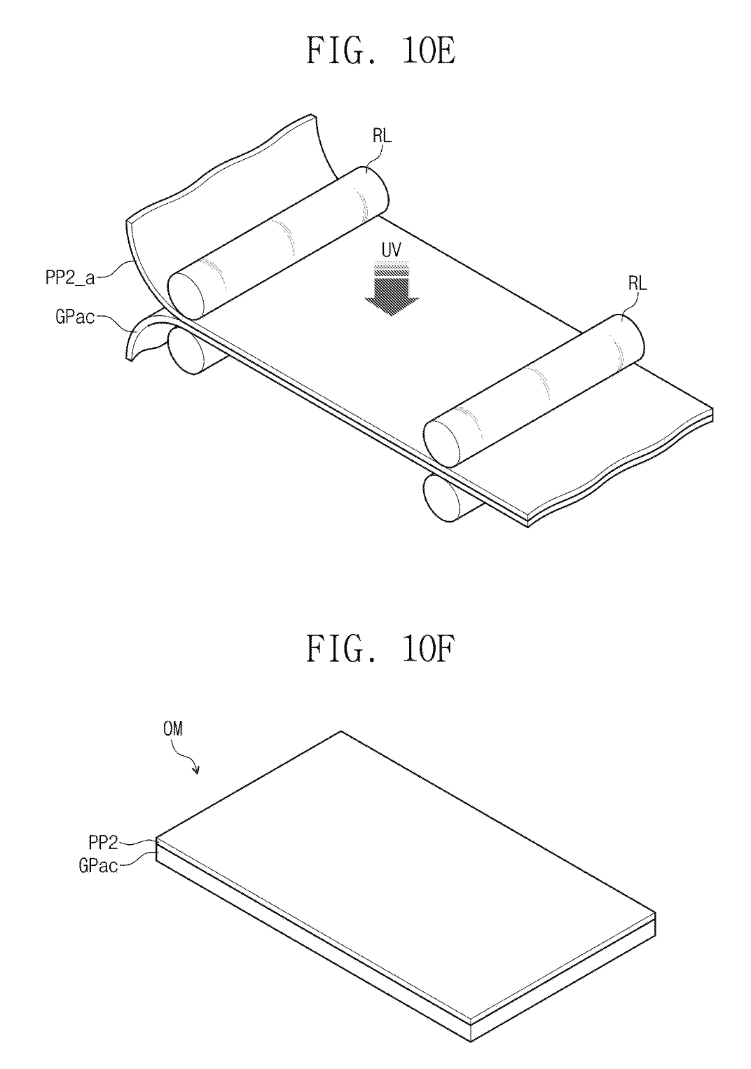

The light condensing patterns PT1 condense the light exiting from the optical member OM to the outside of the optical member OM such that the light may travel in parallel to the third direction DR3. The light condensing patterns PT1 may be uniformly distributed on the film FM. Thus, defects, which are caused by a difference in pressure applied to the light condensing patterns PT1 during a process, in which the second pattern part PP2 is attached to the adhesive part AP, may be reduced. Details thereof will be described later with reference to FIGS. 10A to 10F.

The light condensing patterns PT1 may include at least one of PA, PMMA, MS and PC. Thus, the light condensing patterns PT1 may have the same refractive index as that of the light guide part GP, but not being limited thereto or thereby.

FIG. 2B is a cross-sectional view showing a backlight unit according to an alternative exemplary embodiment of the disclosure. The same or like elements shown in FIG. 2B have been labeled with the same reference characters as used above to describe the exemplary embodiment of the backlight unit shown in FIG. 2A, and any repetitive detailed description thereof will hereinafter be omitted or simplified.

Referring to FIG. 2B, an exemplary embodiment of a backlight unit BLUa includes a light source unit LU, an optical member OMa, and a diffusion member LDS.

The optical member OMa may include a light guide part GP, a first pattern part PP1, an adhesive part AP, and a second pattern part PP2a. The second pattern part PP2a may include a film FM and light condensing patterns PT1.

In such an embodiment, as shown in FIG. 2B, the diffusion patterns DFP (refer to FIG. 2A) may be omitted from the second pattern part PP2a. In such an embodiment, the diffusion member LDS is disposed on the optical member OMa. The diffusion member LDS may be a film in which diffusion beads are distributed, but not being limited thereto or thereby. Alternatively, the diffusion member LDS may be omitted.

FIG. 3 is a plan view showing a backlight unit according to an exemplary embodiment of the disclosure.

Referring to FIGS. 2A and 3, the light guide part GP includes a first area or region AR1 and a second area or region AR2, which are defined along the first direction DR1 when viewed in a plan view. The first direction DR1 corresponds to a direction toward the second side surface SS2 away from the first side surface SS1. The first area AR1 is disposed adjacent to the first side surface SS1, and the second area AR2 is disposed adjacent to the second side surface SS2. The first area AR1 may be referred to as a light incident area, and the second area AR2 may be referred to as a light opposite area.

The first area AR1 and the second area AR2 are distinguished from each other with respect to an imaginary center line CL crossing a center position of the light guide part GP and extending in the second direction DR2. That is, an area between the center line CL and the first side surface SS1 is defined as the first area AR1 when viewed in the plan view, and an area between the center line CL and the second side surface SS2 is defined as the second area AR2 when viewed in the plan view.

The first pattern part PP1 is disposed on both of the first area AR1 and the second area AR2. The first pattern part PP1 may include a control pattern PTa. In an exemplary embodiment as shown in FIG. 3, the first pattern part PP1 includes five control patterns PTa, but not being limited thereto or thereby. In one alternative exemplary embodiment, for example, the number of the control patterns PTa of the first pattern part PP1 may be smaller than, or greater than five.

The control patterns PTa are arranged along the second direction DR2. Each of the control patterns PTa extends in the first direction DR1. In an exemplary embodiment, a width of a control pattern PTa in the first area AR1 is greater than a width of the control pattern PTa in the second area AR2. In an exemplary embodiment, a width in the second direction DR2 of each control pattern PTa becomes narrower as a distance from the first side surface SS1 increases. Therefore, a width PPT1 of each of portions of the control patterns PTa disposed in the first area AR1 is equal to or greater than a maximum width PPT2 of each of portions of the control patterns PTa disposed in the second area AR2. In such an embodiment, a width PPT1 of a control pattern PTa in the first area AR1 at a boundary between the first area AR1 and the second area AR2 may be equal to a width PPT2 of the control pattern PTa in the second area AR2, i.e., the maximum width PPT2 of the control pattern PTa in the second area AR2.

A ratio of an overlapping area of the control patterns PTa with the first area AR1 to the entire area of the first area AR1 when viewed in the plan view is referred to as a first area ratio, and a ratio of an overlapping area of the control patterns PTa with the second area AR2 to the entire area of the second area AR2 when viewed in the plan view is referred to as a second area ratio. In such an embodiment, as described above, since the width in the second direction DR2 of each control pattern PTa becomes narrower as the distance from the first side surface SS1 increases and the distance from the second side surface SS2 decreases, the first area ratio is greater than the second area ratio.

The first pattern part PP1 occupies a greater area in the first area AR1 than in the second area AR2. Thus, the light has a higher chance to be totally reflected in the first area AR1 than in the second area AR2. As a result, the light emitting efficiency in the first area AR1 is different from the light emitting efficiency in the second area AR2. In such an embodiment, the light emitting efficiency in the first area AR1 may be lower than the light emitting efficiency in the second area AR2.

In a case where the light emitting efficiency of the first area AR1 is substantially the same as the light emitting efficiency of the second area AR2, the amount of the light exiting from the first area AR1 is greater than the amount of light exiting from the second area AR2 since the amount of light reaching to the first area AR1 is relatively greater than the amount of light reaching to the second area AR2. Thus, the backlight unit provides the light having non-uniform brightness to the display panel DP. However, according to an exemplary embodiment, the area ratio of the first pattern part PP1 becomes different depending on the position of the first pattern part PP1 in the first and second areas AR1 and AR2 such that the light emitting efficiency of the first area AR1 having a relatively greater amount of light is different from the light emitting efficiency of the second area AR2 having a relatively smaller amount of light. As a result, the backlight unit provides the light having uniform brightness to the display panel DP.

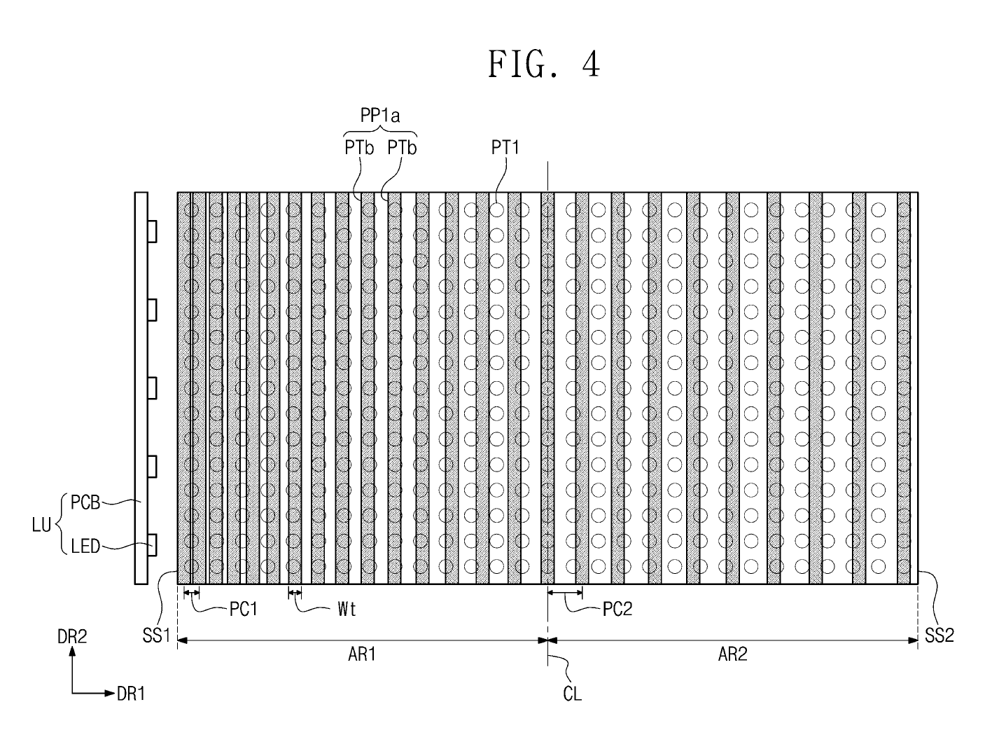

FIG. 4 is a plan view showing a backlight unit according to an alternative exemplary embodiment of the disclosure. The backlight unit shown in FIG. 4 is substantially the same as the backlight unit shown in FIG. 3 except for the first pattern part. The same or like elements shown in FIG. 4 have been labeled with the same reference characters as used above to describe the exemplary embodiment of the backlight unit shown in FIG. 3, and any repetitive detailed description thereof will hereinafter be omitted or simplified.

Referring to FIG. 4, in an exemplary embodiment of the backlight unit, a first pattern part PP1a includes a plurality of control patterns PTb. In such an embodiment, the control patterns PTb are arranged in the first direction DR1, and each of the control patterns PTb extends in the second direction DR2.

A width Wt in the first direction DR1 of each of the control patterns PTb may be constant. Widths Wt in the first direction DR1 of the control patterns PTb may be substantially the same as each other. A pitch between two adjacent control patterns among the control patterns PTb may become different depending on positions of the two control patterns. In one exemplary embodiment, for example, as the two adjacent control patterns are closer to the second side surface SS2 than the first side surface SS1, the pitch between the two adjacent control patterns increases. Therefore, a pitch PC1 of the control patterns disposed in the first area AR1 among the control patterns PTb may be smaller than a minimum pitch PC2 of the control patterns disposed in the second area AR2 among the control patterns PTb. In an exemplary embodiment, where a control patter is disposed at a boundary between the first area AR1 and the second area AR2, a pitch between the control pattern at the boundary and an adjacent control pattern thereof in the first area AR1 may be substantially the same as a pitch between the control pattern at the boundary and another adjacent control pattern thereof in the second area AR2.

In an embodiment, where the first area AR1 has substantially the same size (e.g., area) as that of the second area AR2, the number of the control patterns disposed in the first area AR1 may be greater than the number of the control patterns disposed in the second area AR2 since the pitch increases as the two adjacent control patterns become closer to the second side surface SS2. Thus, the light incident to the first side surface SS1 has a higher chance to be totally reflected in the first area AR1 than in the second area AR2. Accordingly, the light emitting efficiency of the first area AR1 having a relatively greater light amount may be lower than the light emitting efficiency of the second area AR2 having a relatively smaller light amount. As a result, the backlight unit may provide the light having uniform brightness to the display panel DP (refer to FIG. 1).

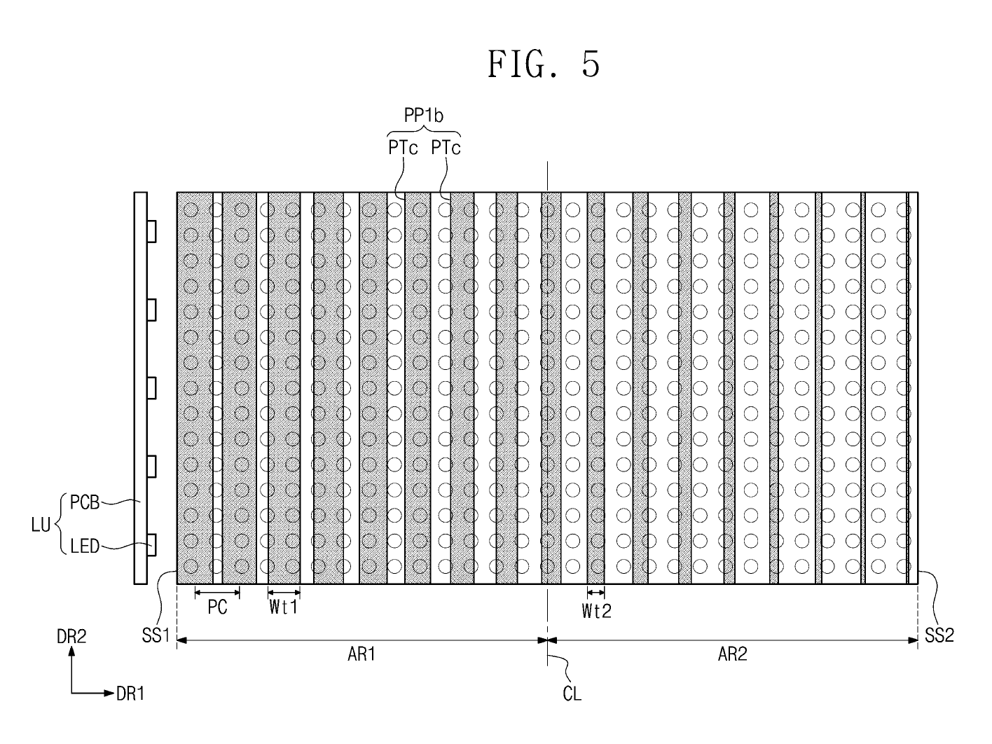

FIG. 5 is a plan view showing a backlight unit according to another alternative exemplary embodiment of the disclosure. The backlight unit shown in FIG. 5 is substantially the same as the backlight unit shown in FIG. 3 except for the first pattern part. The same or like elements shown in FIG. 5 have been labeled with the same reference characters as used above to describe the exemplary embodiment of the backlight unit shown in FIG. 3, and any repetitive detailed description thereof will hereinafter be omitted or simplified.

Referring to FIG. 5, in an exemplary embodiment of the backlight unit, a first pattern part PP1b includes a plurality of control patterns PTc. In such an embodiment, the control patterns PTc are arranged in the first direction DR1, and each of the control patterns PTc extends in the second direction DR2.

A pitch PC between two control patterns adjacent to each other among the control patterns PTc may be constant, and a width in the first direction DR1 of each of the control patterns PTc may be constant. In such an embodiment, as shown in FIG. 5, the widths in the first direction DR1 of the control patterns PTc may be different from each other. In one exemplary embodiment, for example, the width in the first direction DR1 of the control pattern PTc increases as a position of the control pattern becomes closer to the first side surface SS1. In such an embodiment, a width Wt1 of a control pattern in the first area AR1 among the control patterns PTc may be greater than a width of a control pattern in the second area AR2 among the control patterns PTc or a maximum width Wt2 of the control patterns in the second area AR2.

In an embodiment where the first area AR1 has the same size as a size of the second area AR2, the total area of the control patterns PTc in the first area AR1 may be greater than the total area of the control patterns PTc in the second area AR2 since the width of the control patterns PTc increases as the control patterns PTc becomes closer to the first side surface SS1. Thus, the light incident to the first side surface SS1 has a higher chance to be totally reflected in the first area AR1 than in the second area AR2.

According to another alternative exemplary embodiment of the disclosure, the control patterns may be arranged in an arrangement obtained by combining those of the embodiments shown in FIGS. 4 and 5. In such an embodiment, the control patterns may be arranged such that the width of the control patterns may increase as the distance from the first side surface SS1 decreases and the pitch between two adjacent control patterns may decrease as the distance thereof from the first side surface SS1 decreases.

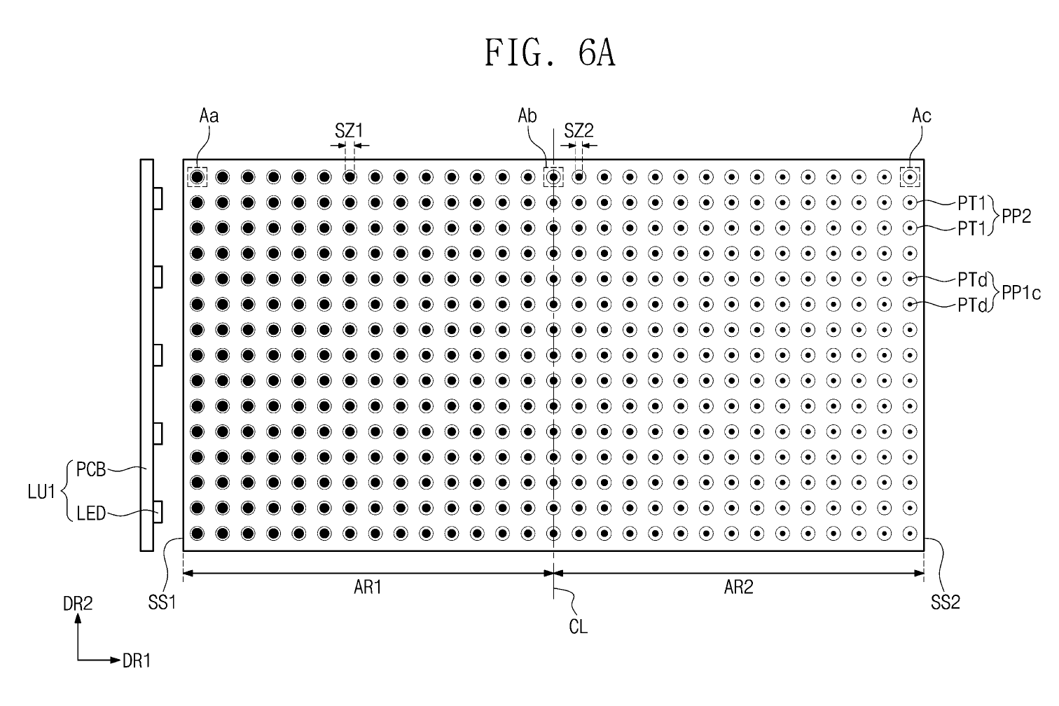

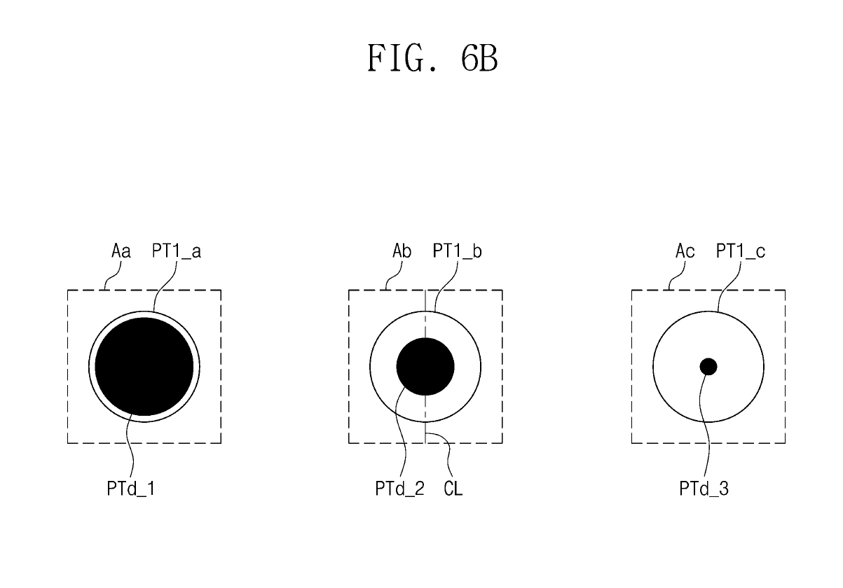

FIG. 6A is a plan view showing a backlight unit according to another alternative exemplary embodiment of the disclosure. FIG. 6B is an enlarged plan view of portions Aa, Ab and Ac shown in FIG. 6A. The backlight unit shown in FIGS. 6A and 6B is substantially the same as the backlight unit shown in FIG. 3 except for the first pattern part. The same or like elements shown in FIGS. 6A and 6B have been labeled with the same reference characters as used above to describe the exemplary embodiment of the backlight unit shown in FIG. 3, and any repetitive detailed description thereof will hereinafter be omitted or simplified.

Referring to FIGS. 6A and 6B, in an exemplary embodiment of the backlight unit, a first pattern part PP1c includes a plurality of control patterns PTd, and a second pattern part PP2 includes a plurality of light condensing patterns PT1.

The control patterns PTd are disposed under or to overlap the light condensing patterns PT1 to be in a one-to-one correspondence with the light condensing patterns PT1. In such an embodiment, one control pattern is disposed under one light condensing pattern. In such an embodiment, as shown in FIG. 6A, the control patterns PTd overlaps the light condensing patterns PT1 when viewed in the plan view.

The light condensing patterns PT1 may have the same size as each other, and a density of the light condensing patterns PT1 arranged in the first area AR1 is the same as that of the light condensing patterns PT1 arranged in the second area AR2.

The control patterns PTd may have different sizes from each other. The size of the control patterns PTd increases as a distance thereof from the first side surface SS1 decreases. Thus, a size (e.g., area) SZ1 of a control pattern arranged in the first area AR1 among the control patterns PTd is greater than a maximum size SZ2 of the control pattern arranged in the second area AR2 among the control patterns PTd.

FIG. 6B is an enlarged view showing three areas of the backlight unit. More particularly, FIG. 6B shows a first light condensing pattern PT1_a and a first control pattern PTd_1, which are disposed in a first partial area Aa most adjacent to the first side surface SS1, a second light condensing pattern PT1_b and a second control pattern PTd_2, which are disposed in a second partial area Ab at the center line CL, and a third light condensing pattern PT1_c and a third control pattern PTd_3, which are disposed in a third partial area Ac most adjacent to the second side surface SS2.

When viewed in the plan view, the first light condensing pattern PT1_a, the second light condensing pattern PT1_b, and the third light condensing pattern PT1_c have the same size as each other, and the first control pattern PTd_1, the second control pattern PTd_2 and the third control pattern PTd_3 have different sizes from each other. In such an embodiment, an amount of the light incident to the first light condensing pattern PT1_a, the second light condensing pattern PT1_b, and the third light condensing pattern PT1_c may be controlled by adjusting the sizes of the first control pattern PTd_1, the second control pattern PTd_2 and the third control pattern PTd_3. Thus, even though the amount of light incident to the light guide part GP (refer to FIG. 2A) is different depending on an area of the light guide part GP, the backlight unit may provide the light having uniform brightness to the display panel DP (refer to FIG. 1) by adjusting the sizes of the first control pattern PTd_1, the second control pattern PTd_2 and the third control pattern PTd_3.

FIG. 7 is a plan view showing a backlight unit according to another alternative exemplary embodiment of the disclosure. The backlight unit shown in FIG. 7 is substantially the same as the backlight unit shown in FIG. 3 except for the first pattern part. The same or like elements shown in FIG. 7 have been labeled with the same reference characters as used above to describe the exemplary embodiment of the backlight unit shown in FIG. 3, and any repetitive detailed description thereof will hereinafter be omitted or simplified.

Referring to FIG. 7, in an exemplary embodiment of the backlight unit, a first pattern part PP1d includes a plurality of control patterns PTe, and a second pattern part PP2 includes a plurality of light condensing patterns PT1. In such an embodiment, as shown in FIG. 7, the control patterns PTe have the same size as each other.

In an exemplary embodiment, as shown in FIG. 6A, the control patterns PTd are disposed under or to overlap the light condensing patterns PT1 to be in a one-to-one correspondence with the light condensing patterns PT1. Alternatively, as shown in FIG. 7, the control patterns PTe are disposed under or to overlap some light condensing patterns of the light condensing patterns PT1 to be in a one-to-one correspondence with the some light condensing patterns. In such an embodiment, the light emitting efficiency in the first area AR1 and the second area AR2 is controlled by adjusting the density of the control patterns PTe in each of the first area AR1 and the second area AR2. In an embodiment, where the first area AR1 and the second area AR2 have the same size or area as each other, the light emitting efficiency in the first area AR1 and the second area AR2 is controlled by adjusting the number of the control patterns PTe in each of the first area AR1 and the second area AR2.

The density of the control patterns disposed in the first area AR1 may be greater than the density of the control patterns disposed in the second area AR2 among the control patterns PTe. Thus, even though the amount of the incident light is different depending on each area of the light guide part GP (refer to FIG. 2A), the backlight unit may effectively provide the light having uniform brightness to the display panel DP (refer to FIG. 1) by adjusting the number or density of the control patterns PTe.

According to another alternative exemplary embodiment, the control patterns may be arranged in an arrangement obtained by combining arrangements of the embodiments shown in FIGS. 6A and 7. In one exemplary embodiment, for example, the size of the control patterns may increase as the distance from the first side surface SS1 decreases, and the density of the control patterns, e.g., the number of the control patterns per a unit area, may increase as the distance from the first side SS1 decreases.

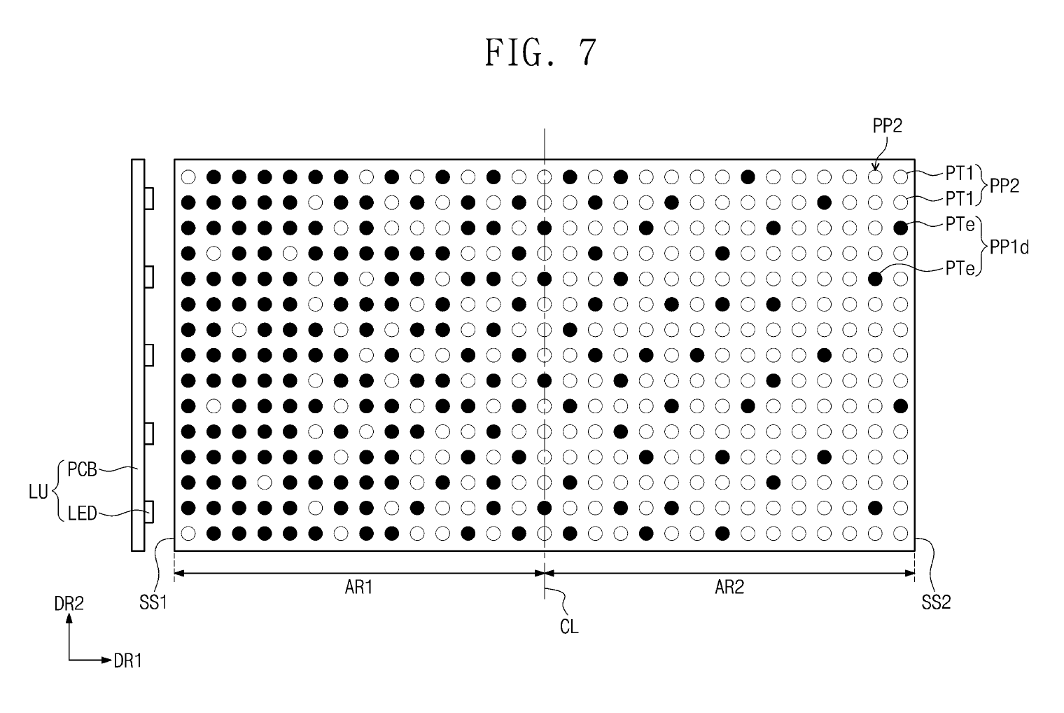

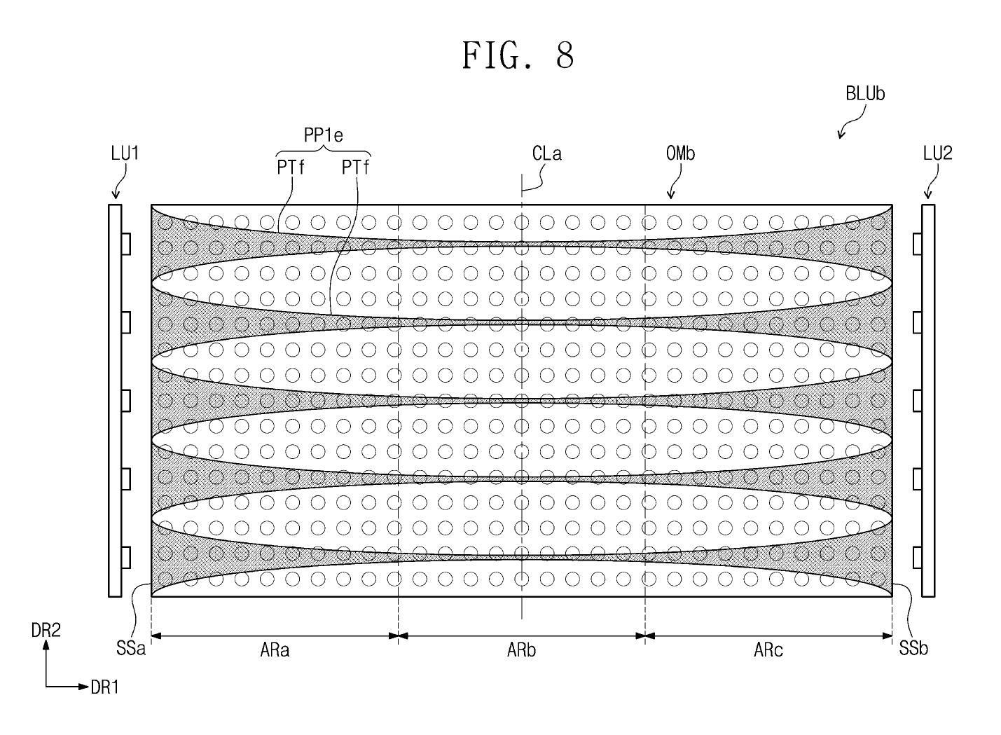

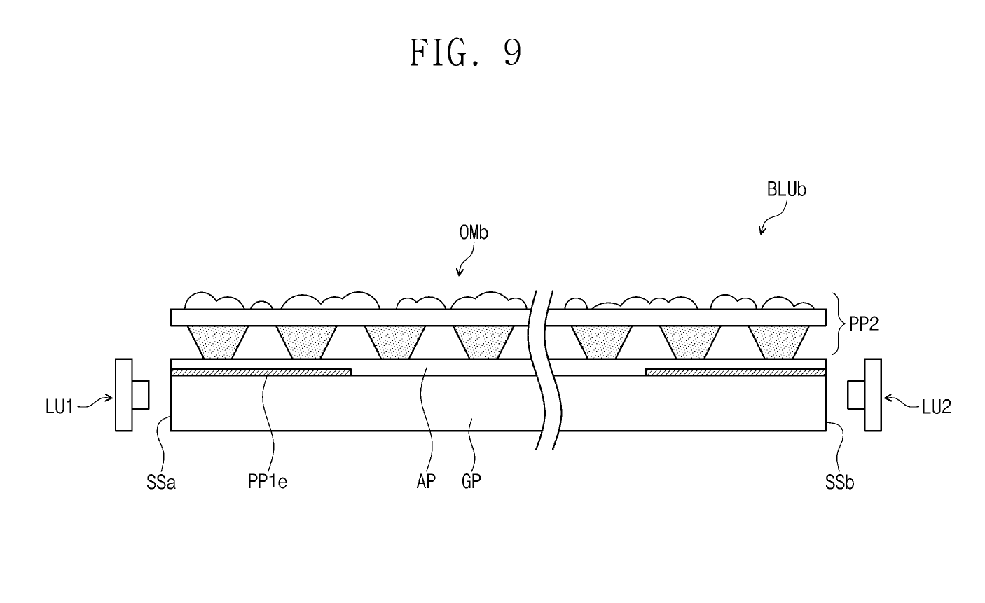

FIG. 8 is a plan view showing a backlight unit according to another alternative exemplary embodiment of the disclosure. FIG. 9 is a cross-sectional view showing the backlight unit of FIG. 8. The backlight unit shown in FIGS. 8 and 9 is substantially the same as the backlight unit shown in FIG. 3 except for the light source unit and the first pattern part. The same or like elements shown in FIGS. 8 and 9 have been labeled with the same reference characters as used above to describe the exemplary embodiment of the backlight unit shown in FIG. 3, and any repetitive detailed description thereof will hereinafter be omitted or simplified.

Referring to FIGS. 8 and 9, an exemplary embodiment of a backlight unit BLUb includes a first light source unit LU1, a second light source unit LU2 and an optical member OMb. The first light source unit LU1 and the second light source unit LU2 face each other, and the optical member OMb is interposed between the first light source unit LU1 and the second light source unit LU2.

A light guide part GP receives a light through a first side surface SSa facing the first light source unit LU1 and a second side surface SSb facing the second light source unit LU2. The light guide part GP includes, or is divided into, a first area ARa, a second area ARb and a third area ARc, which are sequentially arranged in the first direction DR1 when viewed in the plan view.

The first area ARa is disposed adjacent to the first side surface SSa and may be referred to as a first light incident area, and the third area ARc is disposed adjacent to the second side surface SSb and may be referred to as a second light incident area.

A first pattern part PP1e includes a control pattern PTf. In an exemplary embodiment, as shown in FIG. 8, the first pattern part PP1e may include five control patterns PTf, but the number of the control patterns PTf may not be limited to five.

The light emitting efficiency of the optical member OMb is controlled by allowing an area ratio of the first pattern part PP1e defined on the light guide part GP to be different. In one exemplary embodiment, for example, the area ratio of the first pattern part PP1e in the first area ARa and the area ratio of the first pattern part PP1e in the third area ARc are greater than the area ratio of the first pattern part PP1e in the second area ARb. Herein, the area ratio of a pattern part in an area may be defined as a ratio of an area of a portion of the pattern part in the area with respect to an entire area of the area, or an area ratio of an overlapping portion of the pattern part with the area to the area. The control patterns PTf are arranged in the second direction DR2, and each of the control patterns PTf extends in the first direction DR1. A width in the second direction DR2 of each control pattern PTF decreases as a distance from an imaginary center line CLa decreases and increases as the distance from the center line CLa increases. Thus, the control patterns PTf have a minimum width at the center line CLa. The center line CLa crosses a center of the second area ARb and extends in the second direction DR2.

The ratio of an overlapping area of the first pattern part PP1e with the first area ARa to an entire area of the first area ARa when viewed in the plan view is referred to as a first area ratio, the ratio of an overlapping area of the first pattern part PP1e with the second area ARb to an entire area of the second area ARb when viewed in a plan view is referred to as a second area ratio, and the ratio of an overlapping area of the first pattern part PP1e with the third area ARc to an entire area of the third area ARc is referred to as a third area ratio.

In an exemplary embodiment, each of the first area ratio and the third area ratio is greater than the second area ratio. In such an embodiment, the first pattern part PP1e has a shape symmetrical with respect to the center line CLa. According to the exemplary embodiment, the light has a higher chance to be totally reflected in the first area ARa and the third area ARc than in the second area ARb. Accordingly, the light emitting efficiency in the first area ARa and the third area ARc, which have a relatively-large light amount, is lower than the light emitting efficiency in the second area ARb, which has a relatively-small light amount. As a result, the backlight unit BLUb provides the light having uniform brightness to the display panel DP (refer to FIG. 1).

FIGS. 10A to 10F are views showing a method of manufacturing an optical member according to an exemplary embodiment of the disclosure. FIGS. 10A to 10F show an exemplary embodiment of the method of manufacturing an embodiment of the optical member OM described above with reference to FIGS. 2A and 3, and thus, the same or like elements shown in FIGS. 10A to 10F have been labeled with the same reference characters as used above to describe the exemplary embodiment of the backlight unit shown in FIGS. 2A and 3, and any repetitive detailed description thereof will hereinafter be omitted or simplified.

Referring to FIGS. 10A to 10B, in an exemplary embodiment of the method of manufacturing an optical member, an optical film GPa and a mask MK are prepared.

The optical film GPa may be an element that constitutes a light guide part GP of an optical member OM (refer to FIG. 2A), and the optical film GPa may be a film including or formed of at least one of PA, PMMA, MS, and PC, but not being limited thereto or thereby.

In such an embodiment, a hole HL having a shape corresponding to the shape of a first pattern part PP1 is formed through the mask MK. A pattern material having a refractive index smaller than that of the optical film GPa is coated on the optical film GPa using the mask MK. The pattern material may not be limited to a specific material as long as the pattern material has the refractive index smaller than that of the light guide part GP. In one exemplary embodiment, for example, the pattern material may include a material having a refractive index smaller than that of the light guide part GP by about 0.05 or greater.

The pattern material may be an ultraviolet curable material or a thermal curable material. The pattern material is coated on the optical film GPa using the mask MK and cured to form the first pattern part PP1.

Referring to FIG. 10C, an adhesive material AM is provided or deposited on the optical film GPa on which the first pattern part PP1 is provided. The adhesive material AM may be, but not limited to, an optical resin. For convenience of description, the optical film GPa, the first pattern part PP1 and the adhesive material AM will be referred to as a preliminary optical part GPac.

Referring to FIG. 10D, a second preliminary pattern part PP2_a is prepared to be attached to the preliminary optical part GPac. The second preliminary pattern part PP2_a is an element that constitutes the second pattern part PP2 of the optical member OM (refer to FIG. 2A) and includes a film FM, light condensing patterns PT1 and diffusion patterns DFP. The light condensing patterns PT1 are provided or distributed on the film FM with a uniform density. In an exemplary embodiment, the light condensing patterns PT1 may be provided under the film FM, and the diffusion patterns DFP may be provided on the film FM.

The light condensing patterns PT1 may be formed by a roll-to-roll imprint process. In one exemplary embodiment, for example, a light curable resin is provided on the film FM, and a pressure is applied onto a surface where the light curable resin is provided using a pattern roller (not shown). Then, an ultraviolet ray is irradiated to cure the light curable resin, and thus the light condensing patterns PT1 are formed. The pattern roller may be provided with a shape corresponding to the shape of the light condensing patterns PT1, or the pattern roller may be provided with a film on which a pattern corresponding to the light condensing patterns PT1 is formed. However, the method of manufacturing the light condensing patterns PT1 may not be limited thereto or thereby.

Referring to FIG. 10E, the preliminary optical part GPac and the second preliminary pattern part PP2_a are pressed by a roller RL to attach the preliminary optical part GPac and the second preliminary pattern part PP2_a to each other. The preliminary optical part GPac and the second preliminary pattern part PP2_a are attached to each other as the adhesive material AM is cured. In such an embodiment, the light condensing patterns PT1 are attached to the adhesive material AM, and thus the preliminary optical part GPac and the second preliminary pattern part PP2_a are coupled to each other.

A pressure is applied to the light condensing patterns PT1 during a process in which the preliminary optical part GPac and the second preliminary pattern part PP2_a are pressed by the roller RL. According to an exemplary embodiment, the first pattern part PP1 having the refractive index smaller than that of the light guide part GP is provided on the light guide part GP, and the first pattern part PP1 in an area on the light guide part GP has an area ratio depending on the position of the area on the light guide part GP. Thus, even though the light condensing patterns PT1 are distributed with a uniform density, the light emitting efficiency of the optical member OM (refer to FIG. 2A) may be controlled by adjusting the density of the first pattern part PP1. As a result, the light condensing patterns PT1 may be prevented from being deformed due to the pressure difference occurring when the light condensing patterns PT1 have a non-uniform density.

Referring to FIG. 10F, after the preliminary optical part GPac and the second preliminary pattern part PP2_a are attached to each other, the preliminary optical part GPac and the second preliminary pattern part PP2_a may be cut. Accordingly, the optical member OM is manufactured.

Although the exemplary embodiments of the invention have been described, it is understood that the invention should not be limited to these exemplary embodiments but various changes and modifications can be made by one ordinary skilled in the art within the spirit and scope of the invention as hereinafter claimed.

What is claimed is:

1. An optical member comprising:
a light guide part having a first refractive index, wherein a first area and a second area are sequentially defined on an upper surface of the light guide part in a first direction from a side surface of the light guide part; and
a first pattern part disposed on the upper surface of the light guide part and having a second refractive index smaller than the first refractive index,
wherein the first pattern part reflects a portion of a light incident thereto from the light guide part,
wherein a first area ratio of an overlapping portion of the first pattern part with the first area to the first area is greater than a second area ratio of an overlapping portion of the first pattern part with the second area to the second area.

2. The optical member of claim 1, wherein
the first pattern part comprises a control pattern,
the control pattern extends in the first direction, and
a width of the control pattern in a second direction crossing the first direction in the first area is equal to or greater than a maximum width of the control pattern in the second direction in the second area.

3. The optical member of claim 1, wherein
the first pattern part comprises a plurality of control patterns,
each of the plurality of control patterns extends in a second direction crossing the first direction,
the plurality of control patterns is arranged in the first direction,
a width of a control pattern in the first direction in the first area among the plurality of control patterns is greater than a width of a control pattern in the first direction in the second area among the plurality of control patterns.

4. The optical member of claim 1, wherein
the first pattern part comprises a plurality of control patterns,
each of the plurality of control patterns extends in a second direction crossing the first direction,
the plurality of control patterns are arranged in the first direction, and
a pitch between the control patterns disposed in the first area among the plurality of control patterns is smaller than a minimum pitch between the control patterns disposed in the second area among the plurality of control patterns.

5. The optical member of claim 1, further comprising:
an adhesive part which covers the first pattern part; and
a second pattern part attached to the adhesive part.

6. The optical member of claim 5, wherein
the first pattern part comprises a plurality of control patterns,
the second pattern part comprises a plurality of light condensing patterns,
a density of the light condensing patterns in the first area is the same as a density of the light condensing patterns in the second area, and
the plurality of control patterns overlaps the plurality of light condensing patterns when viewed from a plan view in a thickness direction of the light guide part.

7. The optical member of claim 6, wherein an area of a control pattern in the first area among the plurality of control patterns is greater than a maximum area of areas of the control patterns in the second area among the plurality of control patterns.

8. The optical member of claim 6, wherein a number of the control patterns disposed in the first area among the plurality of control patterns is greater than a number of the control patterns disposed in the second area among the plurality of control patterns.

9. The optical member of claim 1, wherein a difference between the first refractive index and the second refractive index is equal to or greater than about 0.05.

10. The optical member of claim 1, wherein
a third area is defined on the upper surface of the light guide part to face the first area such that the second area is disposed between the first area and the third area, and
a third area ratio of an overlapping portion of the first pattern part with the third area to the third area is greater than the second area ratio.

11. The optical member of claim 10, wherein the first pattern part has a shape symmetrical with respect to an imaginary center line crossing a center of the second area in a second direction crossing the first direction.

12. The optical member of claim 1, wherein
the first pattern part makes contact with the light guide part, and
a portion of the light traveling to the first pattern part through the light guide part is reflected at a boundary surface between the first pattern part and the light guide part.

13. A display device comprising:
a display panel which displays an image;
an optical member disposed under the display panel, wherein the optical member comprises:
a light guide part having a first refractive index and comprising a first side surface, a second side surface opposite to the first side surface, and an upper surface connecting the first side surface and the second side surface;
a first pattern part having a second refractive index smaller than the first refractive index and disposed on the upper surface of the light guide part; and
a second pattern part disposed on the first pattern part; and
a first light source unit disposed to face the first side surface, wherein the first light source provides a light to the first side surface,
wherein
a first area and a second area are sequentially defined on the upper surface in a first direction from the first side surface to the second side surface, and
a first area ratio of an overlapping portion of the first pattern part with the first area to the first area is greater than a second area ratio of an overlapping portion of the first pattern part with the second area to the second area.

14. The display device of claim 13, wherein a difference between the first refractive index and the second refractive index is equal to or greater than about 0.05.

15. The display device of claim 13, wherein
the first pattern part comprises a control pattern,
the control pattern extends in the first direction, and
a width of the control pattern in a second direction crossing the first direction decreases as a distance from the second side surface decreases.

16. The display device of claim 13, wherein
the first pattern part comprises a plurality of control patterns,
the plurality of control patterns are arranged in the first direction, and
each of the plurality of control patterns extends in a second direction crossing the first direction.

17. The display device of claim 16, wherein
the control patterns have a same width in the first direction as each other, and
a pitch between two control patterns adjacent to each other among the plurality of control patterns increases as a distance from the second side surface decreases.

18. The display device of claim 16, wherein
the control patterns have different widths in the first direction from each other, and
a width in the first direction of the control patterns decreases as a distance from the second side surface decreases.

19. The display device of claim 18, wherein a pitch between two adjacent control patterns among the plurality of control patterns is constant.

20. The display device of claim 13, further comprising:
an adhesive part covering the first pattern part,
wherein the second pattern part comprises:
a film; and
a plurality of light condensing patterns disposed between a first surface of the film and the adhesive part,
wherein the plurality of light condensing patterns is attached to the light guide part by the adhesive part.

21. The display device of claim 20, wherein a density of the light condensing patterns in the first area is the same as a density of the light condensing patterns in the second area.

22. The display device of claim 20, wherein
the first pattern part comprises a plurality of control patterns, and
the plurality of control patterns overlaps the plurality of light condensing patterns when viewed from a plan view in a thickness direction of the light guide part.

23. The display device of claim 22, wherein an area of the control patterns decreases as a distance from the second side surface decreases.

24. The display device of claim 22, wherein a number of the control patterns disposed in the first area among the plurality of control patterns is greater than a number of the control patterns disposed in the second area among the plurality of control patterns.

25. The display device of claim 20, wherein the second pattern part further comprises a plurality of diffusion patterns disposed on a second surface of the film facing the first surface.

26. The display device of claim 13, further comprising:
a second light source unit disposed to face the second side surface, wherein the second light source provides a light to the second side surface of the light guide part,
wherein
a third area is defined on the upper surface of the light guide part to face the first area such that the second area is disposed between the first area and the third area, and
a third area ratio of an overlapping portion of the first pattern part with the third area to the third area is greater than the second area ratio.

27. The display device of claim 26, wherein the first pattern part has a shape symmetrical with respect to an imaginary center line crossing a center of the second area and extending in a second direction crossing the first direction.

28. The display device of claim 13, wherein
the first pattern part makes contact with the light guide part, and
a portion of the light traveling to the first pattern part through the light guide part is reflected at a boundary surface between the first pattern part and the light guide part.

29. A display device comprising:
a display panel which displays an image;
a backlight unit disposed under the display panel, wherein the backlight unit provides a light to the display panel,
wherein the backlight unit comprises:
an optical member disposed under the display panel; and
a light source which generates the light and provides the light to the optical member,
wherein the optical member comprises:
a light guide part having a first refractive index, wherein a side surface of the light guide part faces the light source to receive the light;
a first pattern part disposed on the upper surface of the light guide part and having a second refractive index smaller than the first refractive index, wherein the first pattern part reflects a portion of the light guided by the light guide part and incident thereto; and
a second pattern part comprising a plurality of light condensing patterns,
wherein
a first area and a second area are defined in an upper surface of the light guide part,
a distance of the first area from the light source is less than a distance of the second area from the light source, and
a first area ratio of an overlapping portion of the first pattern part with the first area to the first area is greater than a second area ratio of an overlapping portion of the first pattern part with the second area to the second area

30. The display device of claim 29, wherein the optical member further comprises:
an adhesive part which covers the first pattern part,
wherein the second pattern part is attached to the adhesive part.

31. The display device of claim 30, wherein
the second light condensing patterns are uniformly distributed on the upper surface of the light guide part when viewed from a plan view in a thickness direction of the light guide part.

32. The display device of claim 29, wherein a difference between the first refractive index and the second refractive index is equal to or greater than about 0.05.

33. The optical member of claim 29, wherein
the first pattern part is in direct contact with the light guide part, and
a portion of the light traveling through the light guide part and incident to the first pattern part is totally reflected at a boundary surface between the first pattern part and the light guide part.
